(19) United States
(12) Patent Application Publication
(10) Pub. No.: US 2004/0193508 A1
(43) Pub. Date: Sep. 30, 2004

(54) Method of and apparatus for providing information on product, and computer program

(75) Inventors: Kosei Takano, Tokyo (JP); Kenji Sakata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/790,698

(22) Filed: Mar. 3, 2004

(30) Foreign Application Priority Data
Mar. 26, 2003 (JP) 2003-086399

(51) Int. Cl. G06F 17/60; G09G 3/36

(52) U.S. Cl. 705/27; 705/14

(57) ABSTRACT

A product-information providing apparatus provides, via a network, a customer device of a customer with information on a product that requires the customer to follow a predetermined operation procedure to operate a predetermined function. The product-information providing apparatus includes an education giving unit that gives an education on the operation procedure of the product to the customer through the customer device, and an education history storing unit that stores a progress of the education taken by the customer as a history of the education given.

### BACKGROUND OF THE INVENTION

1) Field of the Invention

The present invention relates to a technology for providing, via a network, a customer device of a customer with information on operation of a product.

2) Description of the Related Art

Some products require a user of those products to follow a predetermined sequence of steps (operation procedure) to operate a given function of the products. A personal computer (PC) is an example of such products; because, a user of the PC is required to follow an operation procedure to use applications software and hardware of the PC properly, conveniently, and comfortably.

Generally, a vendor of a product provides the users with a customer support regarding the operation procedure of the product. One approach to provide such customer support is to prepare an instruction manual and give it to the users so that the users can refer to the instruction manual if they have a difficulty in operating the product. Other approach is to set up a call center to which the users can make a telephone call whenever they have a query regarding the operation procedure.

As a conventional technology for providing the users with such customer support, a center system has been disclosed in Japanese Patent Laid-Open Publication No. 2000-101773. The system stores a searchable instruction manual of an image forming apparatus. When the system receives a query about an operation from a user's image forming apparatus via a network, the system automatically retrieves operation guidance from the instruction manual based on the information in the query and transmits the operation guidance to the user's image forming apparatus via the network.

The structures of the electric appliances, such as the PCs, and their operation procedures are becoming complicated day by day. As a result the instruction manuals are getting voluminous and difficult to understand. On the other hand, a considerable amount of cost is necessary to set up a call center. The center system disclosed in Japanese Patent Laid-Open Publication No. 2000-101773 is merely an extension of the instruction manuals.

Moreover, the retail prices of the PCs generally include an extra charge for providing the customer support added to the actual price. However, the vendor only relies on a technical forecast when estimating a cost for the customer support; and the vendor ends up with investing more than actually necessary. Besides, advanced users hardly refer to the instruction manuals or make telephone calls to the call centers so that the extra charge is certainly an unnecessary burden on such users.

It is extremely important whether the customer support is provided with ease and at low cost.

### SUMMARY OF THE INVENTION

The object of the present invention is to provide a means and a method that allows the customer support to be provided with ease and at low cost.

An apparatus according to an aspect of the present invention provides, via a network, a customer device of a customer with information on a product that requires the customer to follow a predetermined operation procedure. The product-information providing apparatus includes an education giving unit that-gives an education on the operation procedure of the product to the customer through the customer device, and an education history storing unit that stores a progress of the education as a history of the education given.

A method according to another aspect of the present invention provides, via a network, a customer device of a customer with information on a product that requires the customer to follow a predetermined operation procedure. The method includes giving an education on the operation procedure of the product to the customer through the customer device, and storing a progress of the education as a history of the education given.

A computer program according to still another aspect of the present invention realizes the method according to the above aspect on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an education system according to an, embodiment of the present invention;

FIG. 2 is a flowchart of a process procedure performed by the education system;

FIG. 3 is a block diagram of an education server;

FIG. 4A and FIG. 4B are examples of contents of a customer master in the education server;

FIG. 5A and FIG. 5B are examples of contents of an education course master in the education server;

FIG. 6 is an example of contents of a course attendance master in the education server;

FIG. 7 is an example of contents of a certification master in the education server;

FIG. 8 is a flowchart of process procedure performed by a promotion conducting unit in the education server;

FIG. 9 is a flowchart of process procedure performed by an education giving unit in the education server;

FIG. 10 is a flowchart of process procedure performed by a course completion data storing unit in the education server;

FIG. 11 is an example of a sample screen displayed on a monitor of a customer device;

FIG. 12 is another example of a sample screen displayed on the monitor of the customer device;

FIG. 13 is a block diagram of a vendor server;

FIG. 14 is an example of contents of a customer master in the vendor server;

FIG. 15 is an example of contents of a product master in the vendor server;

FIG. 16 is an example of contents of a sales master in the vendor server;

FIG. 17 is an example of contents of a discount table master in the vendor server;

FIG. 18 is a flowchart of process procedure performed by a product sales unit in the vendor server;

FIG. 19 is a flowchart of process procedure performed by a coupon issuing unit in the vendor server;

FIG. 20 is a flowchart of process procedure performed by a supplementary promotion unit in the vendor server;

FIG. 21 is still another example of a sample screen displayed on the monitor of the customer device;

FIG. 22 is a schematic of a computer system according to another embodiment of the present invention; and

FIG. 23 is a block diagram of a main unit of the computer system.

### DETAILED DESCRIPTION

Exemplary embodiments of an apparatus, a method, and a computer program that realizes the method on a computer, according to the present invention are explained in detail with reference to the accompanying drawings. A system for giving an education to a customer (hereinafter, “education system”) is explained below as an embodiment of the present invention, although the present invention is not limited to the education system.

The term “product” refers to a product for which a predetermined sequence of steps (operation procedure) is required to operate a given function of the product. A personal computer (PC), for instance, is one example of the product because the PC requires a customer to follow a predetermined operation procedure to use various hardware and applications software.

The term “education” refers to lessons given or taken through the Internet (e-learning) about how to use the product. For example, “Connecting to the Internet for the first time” and “Advanced CGI Programming” are the topics that fall under this category.

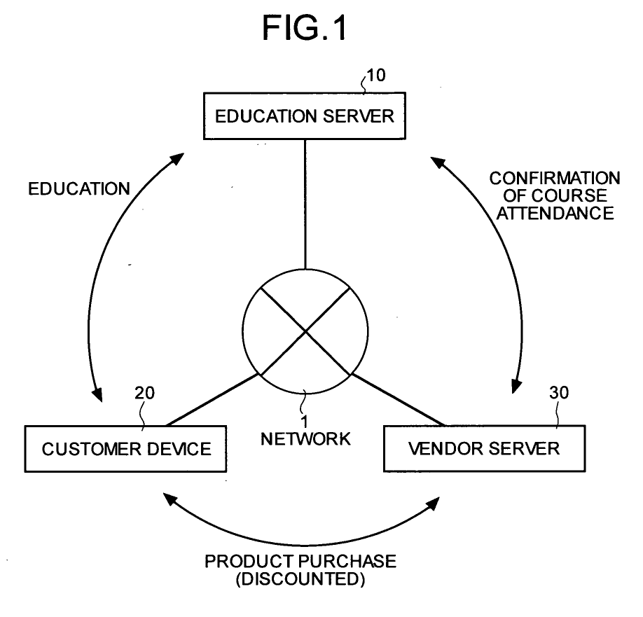

FIG. 1 is a schematic of an education system according to an embodiment of the present invention. The education system includes an education server 10, a customer device 20 of a customer, a vendor server 30 of a personal computer (PC) vendor, and a network 1 such as the Internet. The education server 10, the customer device 20, and the vendor server 30 are connected to each other via the network 1.

The education server 10 and the vendor server 30 are linked up together to provide the customer device 20, via the network 1, with information on the PCs sold by the PC vendor. The customer device 20 can be a PC, a workstation, a home game machine, an Internet TV, or a mobile communication terminal such as a personal digital assistance (PDA), a cellular telephone, and a personal handyphone system (PHS) terminal.

One of the features of the present invention is that the education server 10 gives the customer, via the customer device 20, an education that is relevant to the operation of the PC the customer has purchased or is planning to purchase from the vendor of the PC. Because the vendor does not have to invest lots of time and money to prepare an instruction manual or to set up a call center, the burden on the vendor is reduced. On the other hand, the customer can take the education related to the PC at ease and also can buy the PC at a lower price because the retail price includes less extra charge for creating an instruction manual or setting up a call center.

Another feature of the present invention is that the education server 10 conducts a test to assess an accomplishment of the education taken by the customer. This stimulates the customer's motivation for learning, and at the same time, effectively improves the customer's understanding of the operation of the PC.

Still another feature of the present invention is that the education system gives a discount if the customer buys the PC after taking the education, or issues a coupon if the customer has already bought the PC before completing the education provided by the education server 10. This encourages the customers to buy the PCs; because, they get the PCs at a lower price.

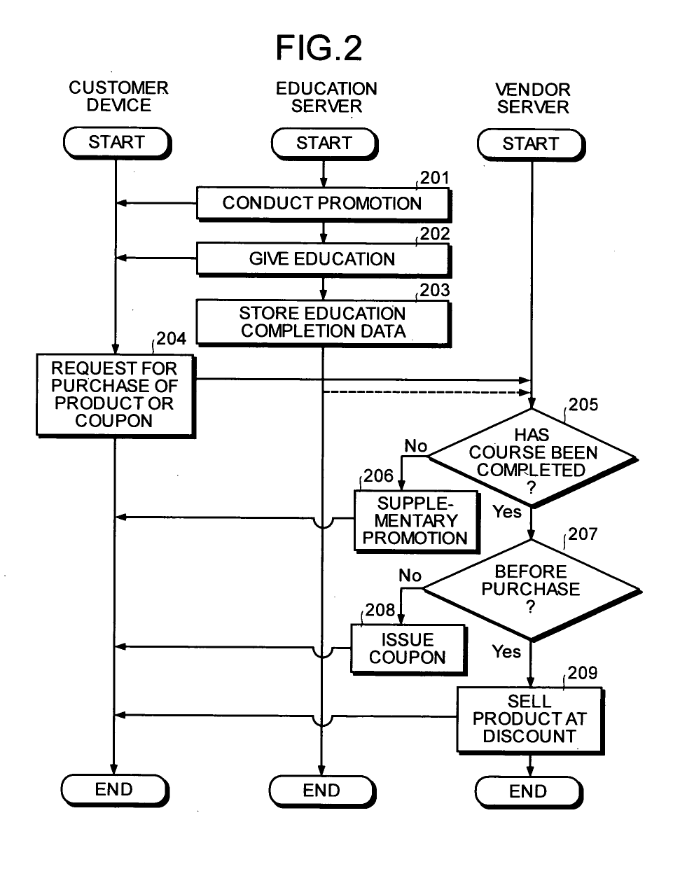

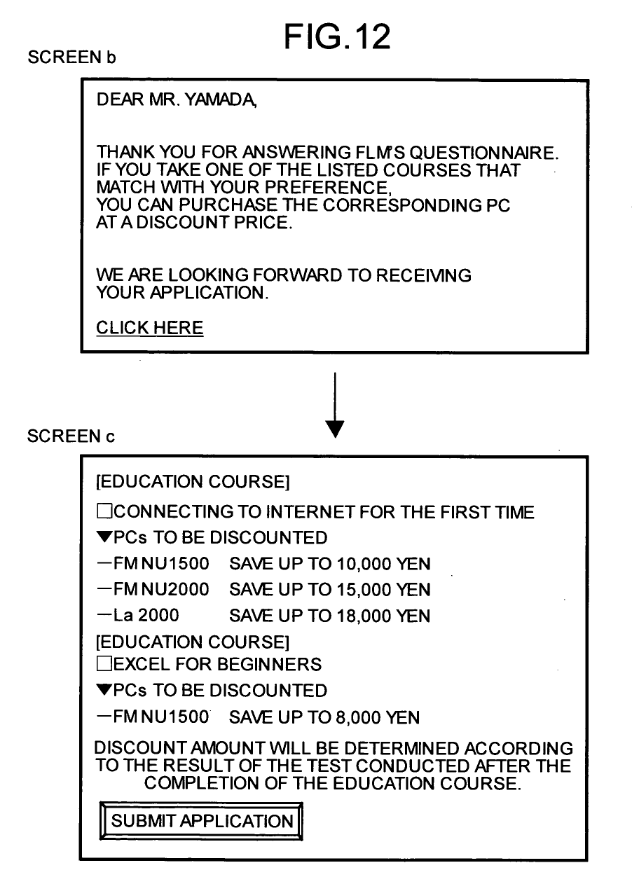

FIG. 2 is a flowchart of a process procedure performed by the education system. The education server 10 sends a direct mail (DM) message to the customer devices 20 of prospective buyers to inform them that some PCs are available at a discount price if they take an education course (step S201). The education course is offered by the education server 10, and is relevant to the PC the customer is going to purchase. The DM message is displayed on monitors of the customer devices 20 of prospective buyers as shown in FIG. 12 (screens b and c).

If a customer from among the prospective buyers decides to purchase a PC, he/she shall reply to the DM message, indicating an education course he/she would like to take. When such reply is received, the education server 10 performs a series of processing to give the customer the education course desired by him/her (step S202). Once the education is finished, the education server 10 conducts a test for the customer and stores the marks obtained by the customer as a history (step S203). Once the test is conducted, the education server 10 sends a DM message to the customer device 20 of the customer who has taken the test. The DM message includes a list of the PCs that are available at discount prices because the customer has taken the education course.

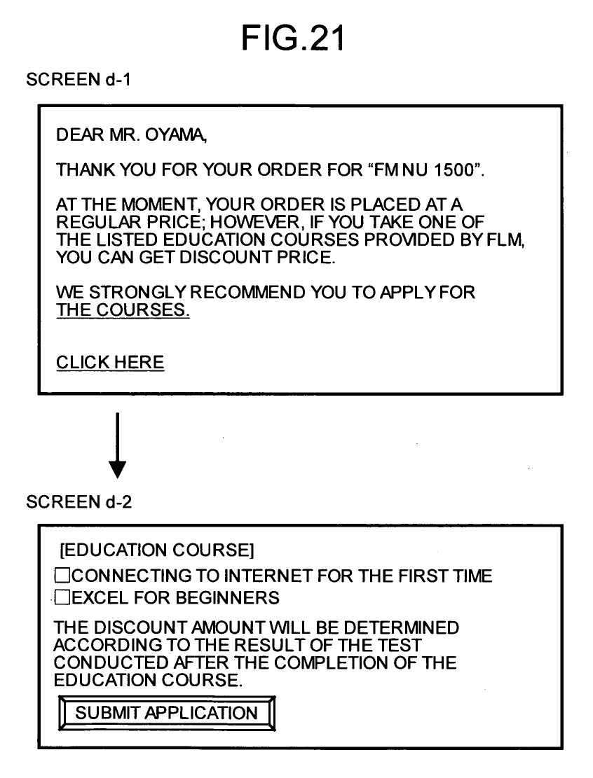

If the customer has already purchased a PC from the vendor, the customer shall reply by mentioning that he/she has already purchased the PC and therefore would like to get a coupon, or if the customer decides to purchase a PC, the customer shall reply by selecting a PC from among the list of PCs included in the DM message (step S204). The reply from the customer goes to the vendor server 30. Upon receiving the reply, the vendor server 30 checks whether the PC mentioned in the reply is really to be sold at a discount and whether the customer has taken the necessary education course (step S205). If the customer has not taken the education course (“No” in step S205), the vendor server 30 sends a DM message including the content shown in. FIG. 21 (screens d-1 and d-2) to the customer device 20 of the customer. The DM message tells that the PC selected by the customer is only available at a discounted price provided that the customer has taken the education course offered by the vendor of the PC (step S206).

If the customer has already taken the education course (“Yes” in step S205), the vendor server 30 checks whether the customer has already purchased the PC (step S207). In other words, the vendor server 30 checks whether the customer has taken the education course before purchasing the PC or after purchasing the PC. If the customer has not purchased the PC (“Yes” in step S207), the vendor server 30 sells the PC desired by the customer. If the customer has taken the course after purchasing the PC (“No” in step S207), since the customer has already purchased the PC at a regular price, the vendor server 30 issues to the customer a coupon of an amount equivalent to the discount (step S208).

Thus, the customer can get the customer support through the e-learning conducted by the education server 10 and also purchase the PC at a discounted price. On the other hand, if the customer has purchased the PC before taking the education course, the customer can get a coupon that can be used to get discount when purchasing other items from the vendor.

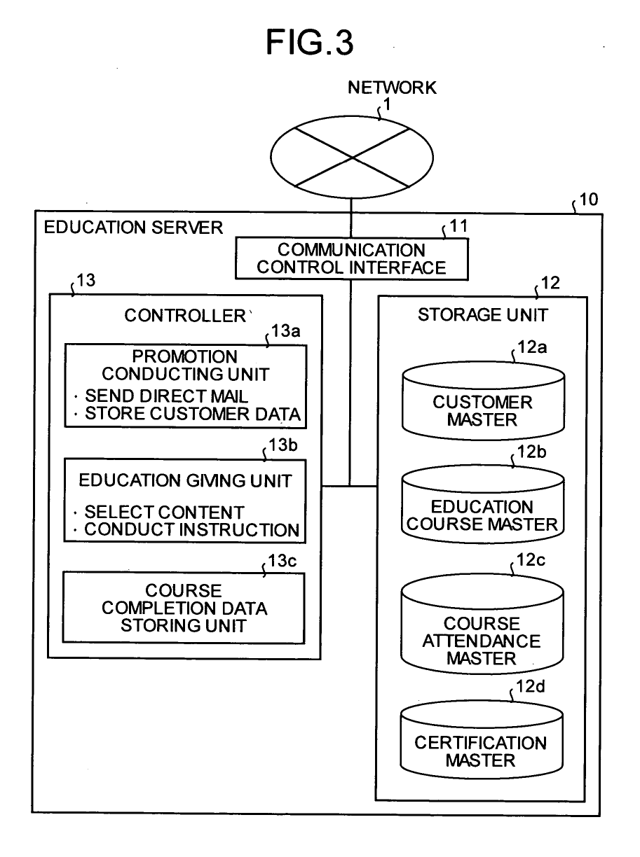

FIG. 3 is a block diagram of the education server 10. The education server 10 includes a communication controller interface (I/F) 11, a storage unit 12, and a controller 13. The communication control I/F 11 controls communication between the customer device 20 and the vendor server 30 via the network 1.

The storage unit 12 stores computer programs and data. The data is, for example, web data to be displayed on a screen of a monitor of the customer device 20. The storage unit 12 includes a customer master 12a, an education course master 12b, a course attendance master 12c, and a certification master 12d.

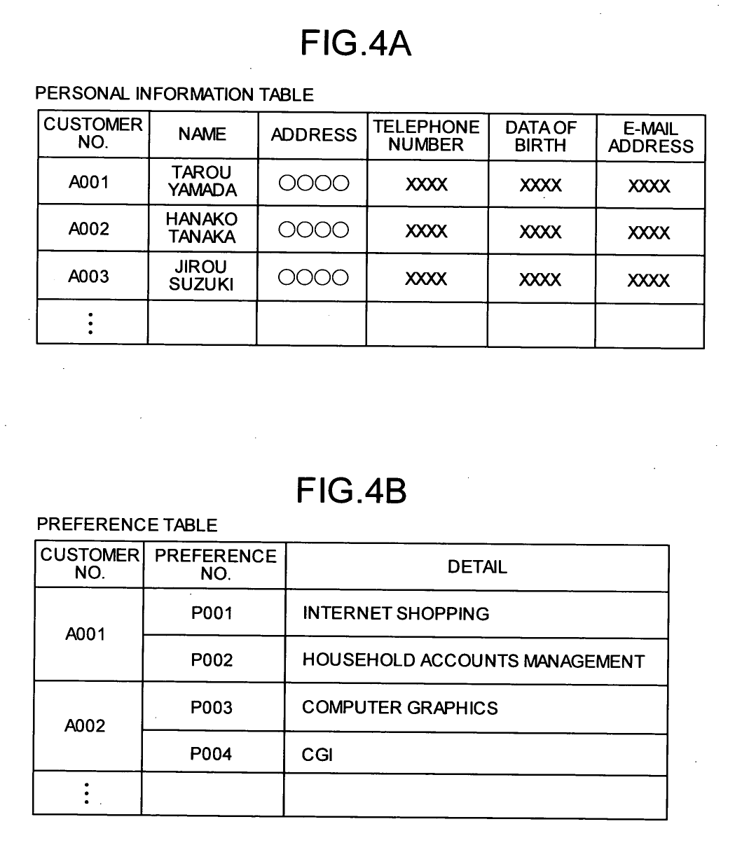

The customer master 12a stores personal information of a customer who is going to take an education course. The personal information includes a “personal information table” (see FIG. 4A) and a “preference table” (see FIG. 4B). The personal information table contains information such as name, address, telephone number, date of birth, and e-mail address corresponding to a customer number for each of the customers. The preference table contains a preference number and a detail of preference of the customer corresponding to the customer number.

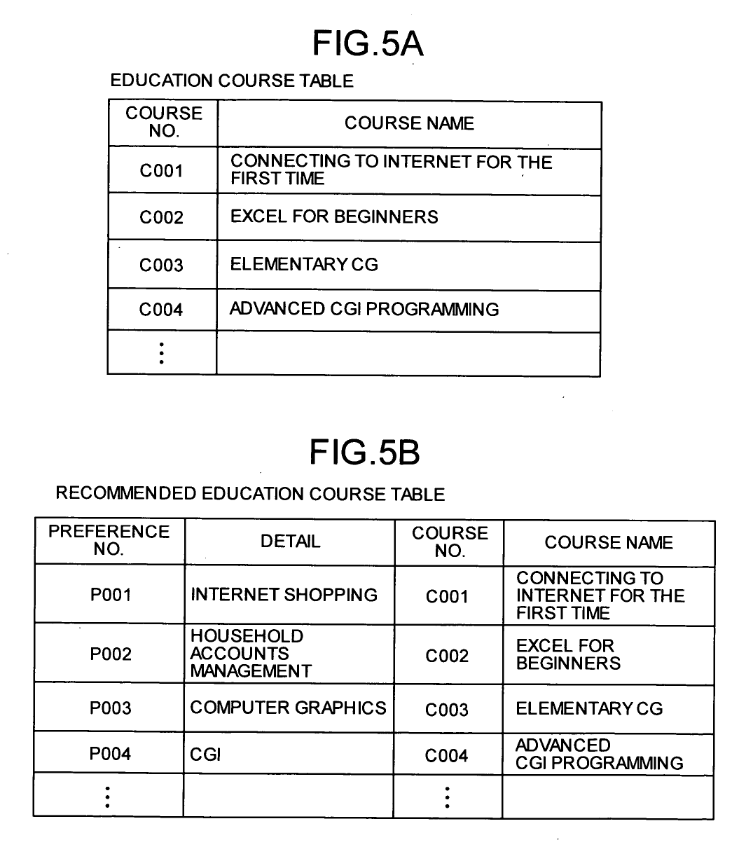

The education course master 12b stores data related to education courses offered by the education server 10. The data includes an “education course table” (see FIG. 5A) and a “recommended education course table” (see FIG. 5B). The education course table contains a course number, a course name, and information relating to a method of giving the education. For example, the education may be given by sending an e-mail or web data to the customer device 20 of the customer. The recommended education course table contains course name and course number of an appropriate education course that matches the preference number and the detail of preference.

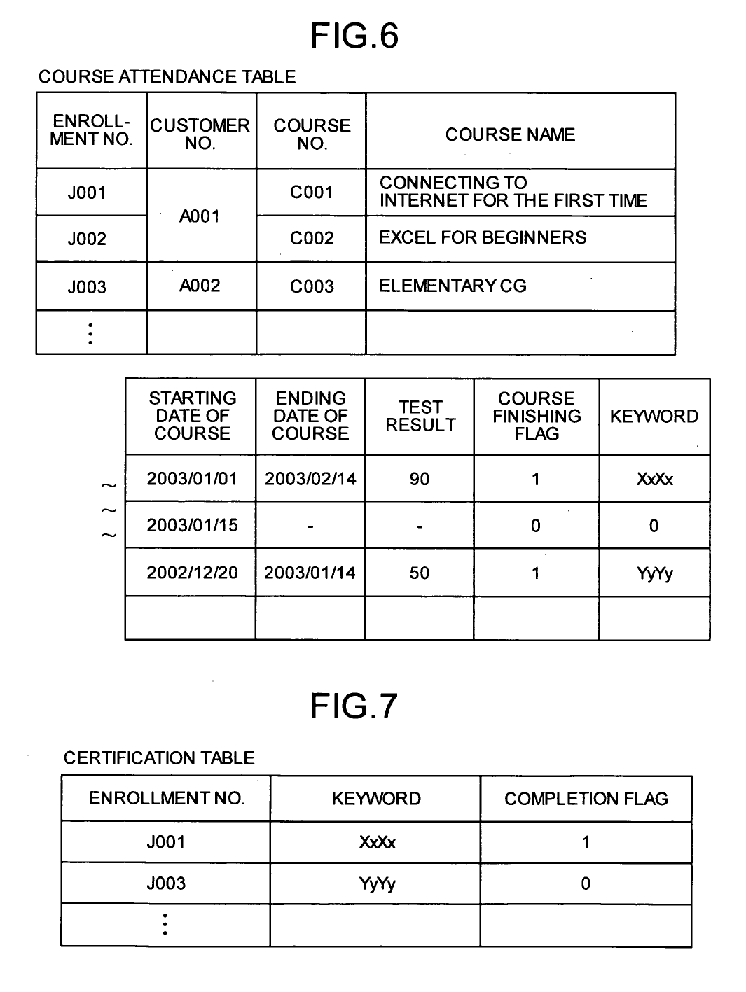

The course attendance master 12c stores a progress of the education taken by the customer as a history. The history includes a “course attendance table” (see FIG. 6) that contains customer number, course number, course name, starting date of each course, ending date of each course, test result, course finishing flag, keyword, and enrollment number. The course finishing flag is set to “05” if the customer has yet to take the education course and set to “1” if the customer has taken the education course. The keyword is a password used for certifying that the customer has taken the course.

The certification master 12d stores certification data for certifying when the customer has taken the education course. The certification data includes a “certification table” (see in FIG. 7) that contains keyword and completion flag for each enrollment number. The completion flag is set to “0” if the customer has yet to take a discount and set to “1” if the customer has taken the discount. The enrollment number and the keyword in the certification table correspond to the enrollment number and the keyword in the course attendance table in the course attendance master 12c.

The controller 13 has an internal memory (not shown). The internal memory stores a control program such as an operating system (OS), computer programs for performing predetermined process procedures (for example, a customer certification program), and data required to execute the control program and the computer programs. The controller 13 executes various processes by running the computer programs stored in the internal memory. The controller also includes a promotion conducting unit 13a, an education giving unit 13b, and a course completion data storing unit 13c.

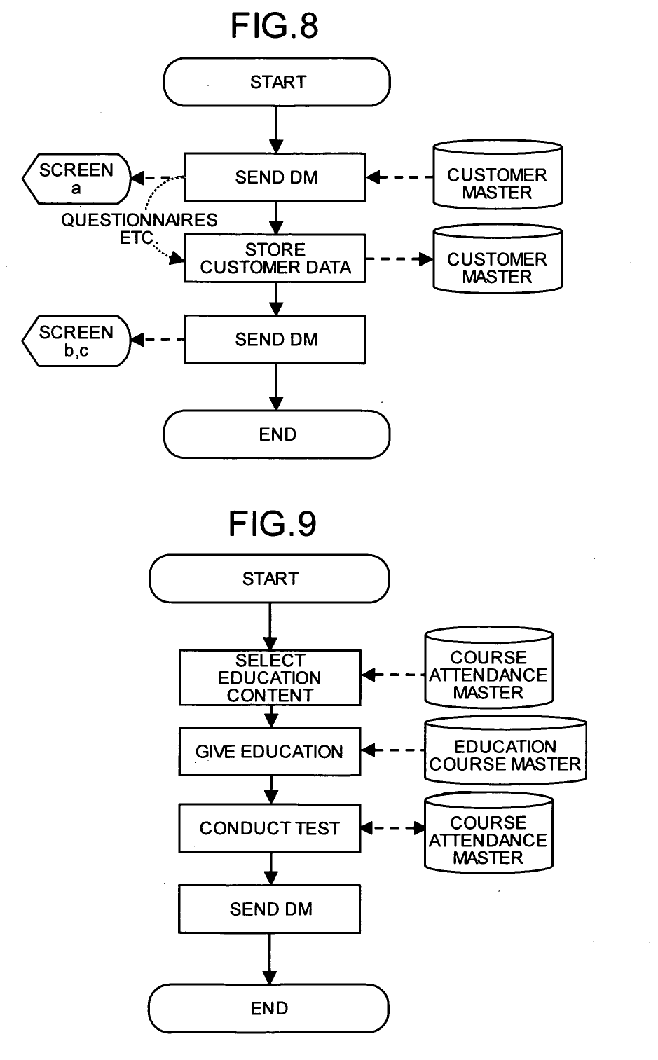

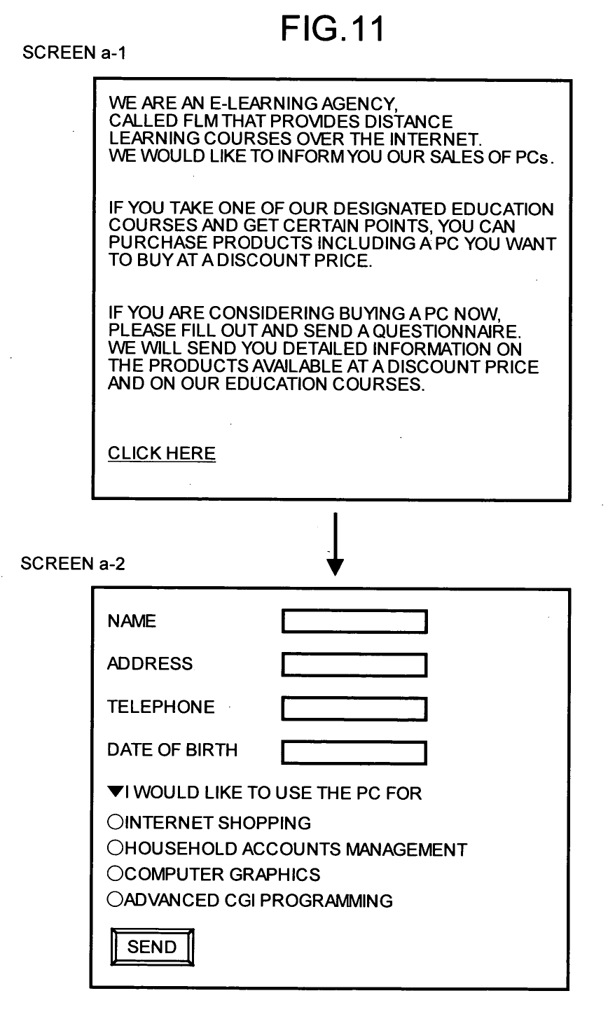

The promotion conducting unit 13a handles various processes for advertising the education system, as shown in FIG. 8. In other words, the promotion conducting unit 13a first sends a DM message that includes contents shown in FIG. 11 (screens a-1 and a-2) to the customer devices 20 of the prospective buyers to encourage them to register customer information. If a customer gives a response to the DM message, the promotion conducting unit 13a receives the response and stores the customer data included in the response in the customer master 12a (see FIG. 4A and FIG. 4B). The customer information may be a name and an address of the customer and a purpose for which the customer is using a PC. Then, the promotion conducting unit 13a sends another DM message that includes contents shown in FIG.12 to those customers who have given the response. The DM message includes a message that certain PCs are available at a discount price if the customer takes a predetermined education course offered by the vender.

Which education courses are relevant to the customers is determined based on the customer information stored in the preference table (see FIG. 4B) and the recommended education course table (see FIG. 5B). If the customer makes an application for an education course from among the educational courses relevant to him/her, the course attendance master 12c stores data included in the application in the course attendance table (see FIG. 6).

The education giving unit 13b handles, as shown in FIG. 9, various processes related to the education to be given to the customers. In other words, the education giving unit 13b refers to the course attendance table (see FIG. 6), extracts data related to the education course to be given to each customer, and loads the data to offer the education to the customer.

When the customer finishes taking the education course, the education giving unit 13b conducts a test to check how much the customer has understood the contents of the education course. A result of the test, a course finishing flag, and a keyword are stored as a history in the course attendance table (see FIG. 6). The education giving unit 13b then sends a DM message to the customer device 20 of the customer who has taken the test. The DM message includes a list of the PCs that are available at discount prices because the customer has taken the education course.

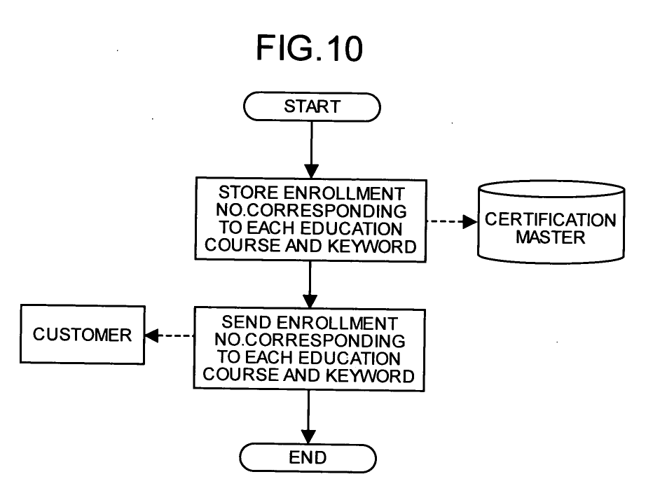

The course completion data storing unit 13c handles, as shown in FIG. 10, various processes to be conducted after the completion of the education course. In other words, the course completion data storing unit 13c stores the enrollment number corresponding to each education course that has been completed by the customer and the keyword of the customer in the certification master 12d, and sets the completion flag to “1”. The course completion data storing unit 13c then sends the enrollment number corresponding to each education course and the keyword to the customer device 20 of the customer.

Subsequently, the course completion data storing unit 13c sends the certification data stored in the certification master 12d to the vendor server 30. Then, the vendor server 30 stores the certification data in synchronization with the education server 10.

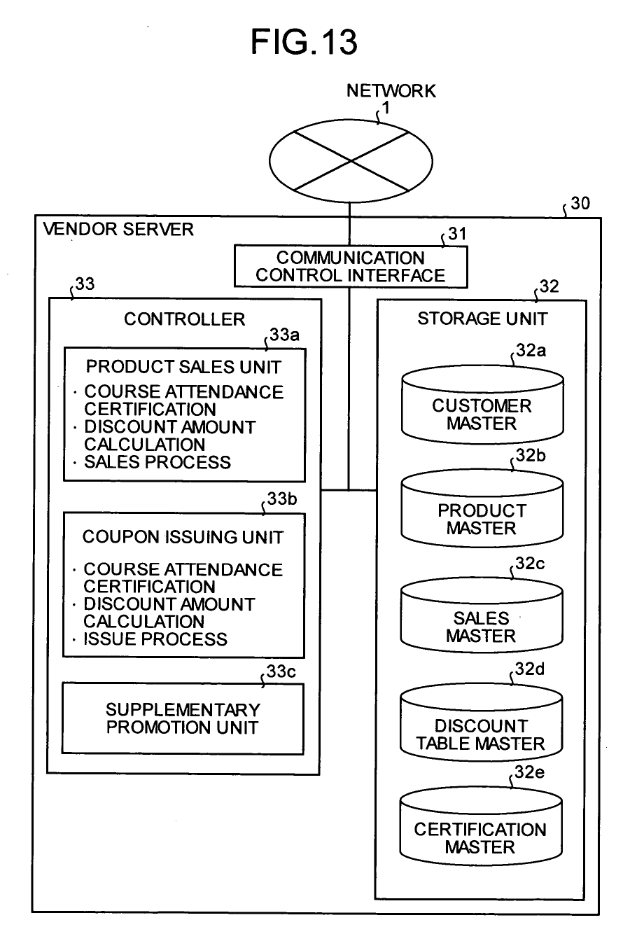

FIG. 13 is a block diagram of the vendor server 30. The vendor server 30 includes a communication control interface 31, a storage unit 32, and a controller 33. The communication control interface 31 controls communication between the customer device 20 and the education server 10 via the network 1.

The storage unit 32 stores computer programs and data. The data is, for example, web data to be displayed on the customer device 20. The storage unit 32 includes a customer master 32a, a product master 32b, a sales master 32c, a discount table master 32d, and a certification master 32e.

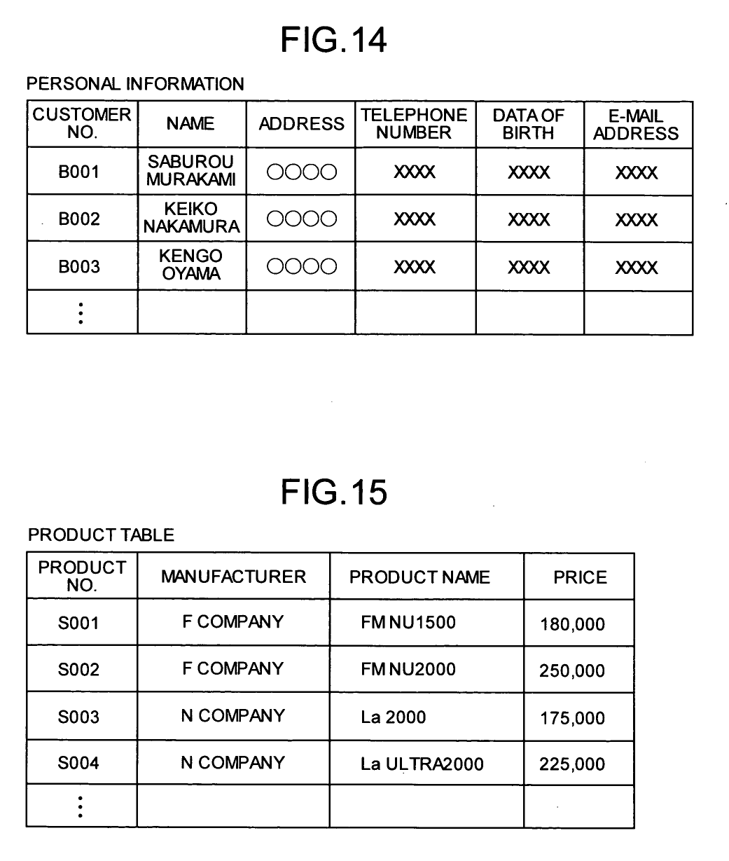

The customer master 32a stores personal information of the customer. The personal information includes a “personal information table” (see FIG. 14) that contains name, address, telephone number, date of birth, and e-mail address of each of the customers.

The product master 32b stores data related to the PCs that are sold by the vendor. The data includes a “product table” (see FIG. 15) that contains name of a manufacturer of the PC, product name, and price of the PC.

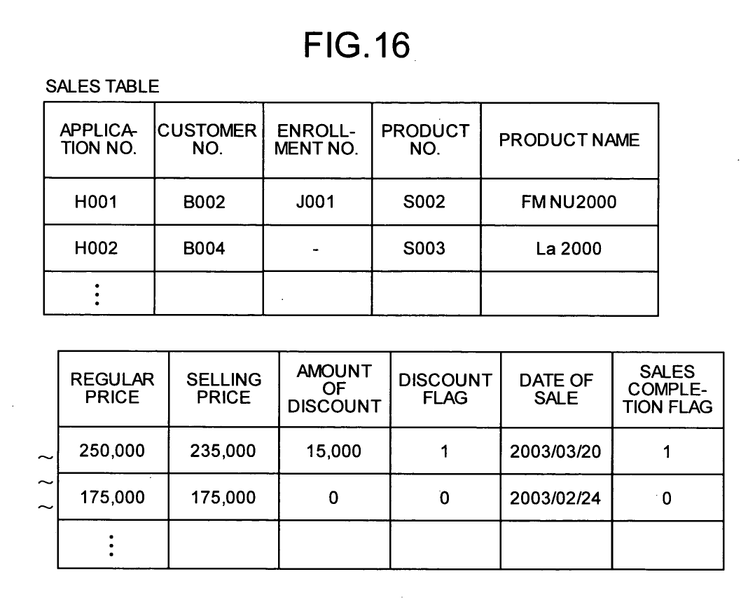

The sales master 32c stores data related to sales performance of the vendor server 30. The data includes a “sales table” (see FIG. 16) that contains customer number, enrollment number, product number, product name, regular price, selling price, amount of discount offered, discount flag (set to “0” before giving the discount), date of sale, sales completion flag (set to “0” before selling the PC) for each of the purchase request number.

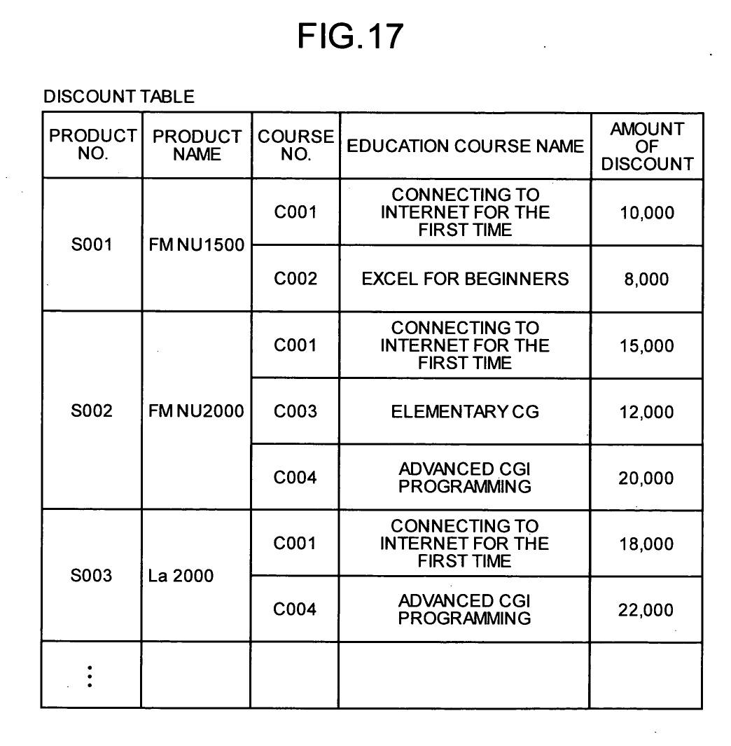

The discount table master 32d stores data related to the discount offered on the products. The data includes a “discount table” (see FIG. 17) that contains product name, course number of education course that offers a discount price, education course name, amount of discount for each of the product numbers.

The certification master 32e stores certification data for certifying that the customer has taken the education course. The certification data includes a “certification table” (see FIG. 7) that contains keyword and completion flag for each enrollment number. The completion flag is set to “0” if the customer has yet to take a benefit such as a discount. The certification master 32e also stores a progress of the education taken by the customer as a history. The history includes a “course attendance table” (see FIG. 6) that contains customer number, course number, course name, starting date of each course, ending date of each course, test result, course finishing flag, keyword, and enrollment number.

The controller 33 has an internal memory (not shown). The internal memory stores a control program such as an operating system (OS), computer programs for performing predetermined process procedures, and data required to execute the control program and the computer programs. The controller 33 executes various processes by running the computer programs that are stored in the internal memory. The controller 33 also includes a product sales unit 33a, a coupon issuing unit 33b, and a supplementary promotion unit 33c.

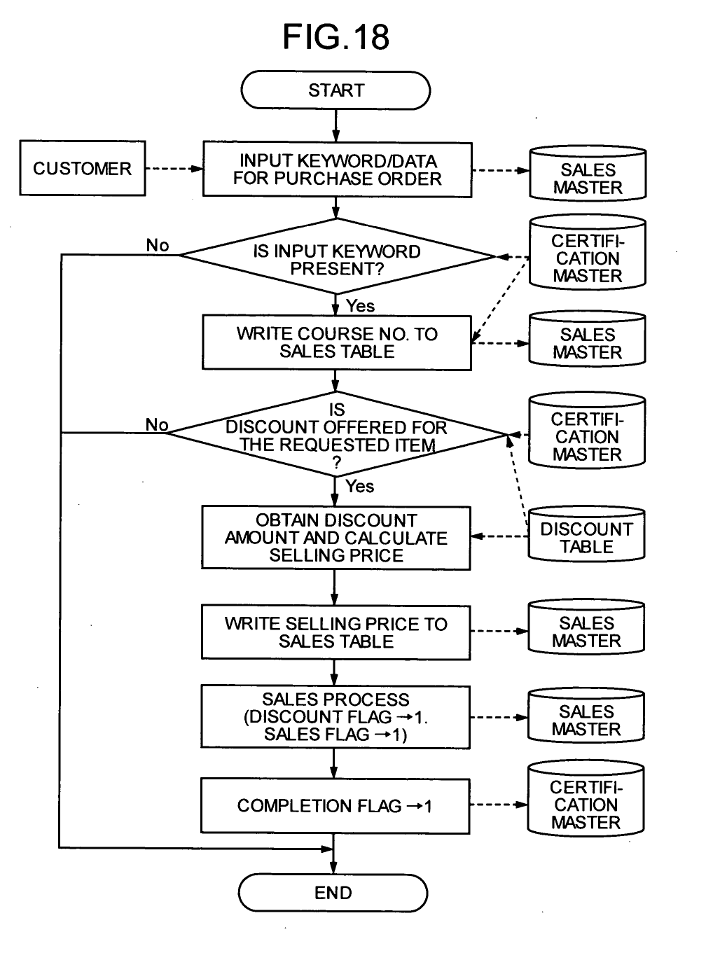

The product sales unit 33a handles various processes for the sale of the PCs, as shown in FIG. 18. In other words, when there is a request for purchasing a PC from the customer device 20 of the customer, the product sales unit 33a displays on the monitor of the customer device 20 of the customer screens that request the customer to enter their personal information, the product name of the PC that the customer has purchased, and the keyword provided to the customer upon completion of the education course. The product sales unit 33a stores all the data received from the customer in the sales table (see FIG. 16) in the sales master 32c (see FIG. 16). The product sales unit 33a then checks whether the keyword supplied by the customer is present in the certification table (see FIG. 7) in the certification master 32e. If the keyword is present, the product sales unit 33a writes the education number corresponding to the keyword in the sales table in the sales master 32c.

The product sales unit 33a then refers to the discount table (see FIG. 17) in the discount table master 32d and checks if the PC that the customer desires to buy is available at a discount price. The product sales unit 33a then refers to the sales table in the sales master 32c and the certification table in the certification master 32e to check whether the customer has taken an education course relevant to the PC he/she is going to purchase. If the customer has taken the education course and the PC that the customer desires to purchase is available at a discount price, the product sales unit 33a acquires the discount value from the discount table in the discount table master 32d, calculates the selling price of the PC, and writes the selling price in the sales table in the sales master 32c. The product sales unit 33a then sets both the discount flag and the sales completion flag to “1” in the sales table in the sales master 32c to indicate that the sales process has been completed, and sets the completion flag to “1” in the certification table in the certification master 32e as a proof that the discount has been given to the customer in return of the education course taken by the customer.

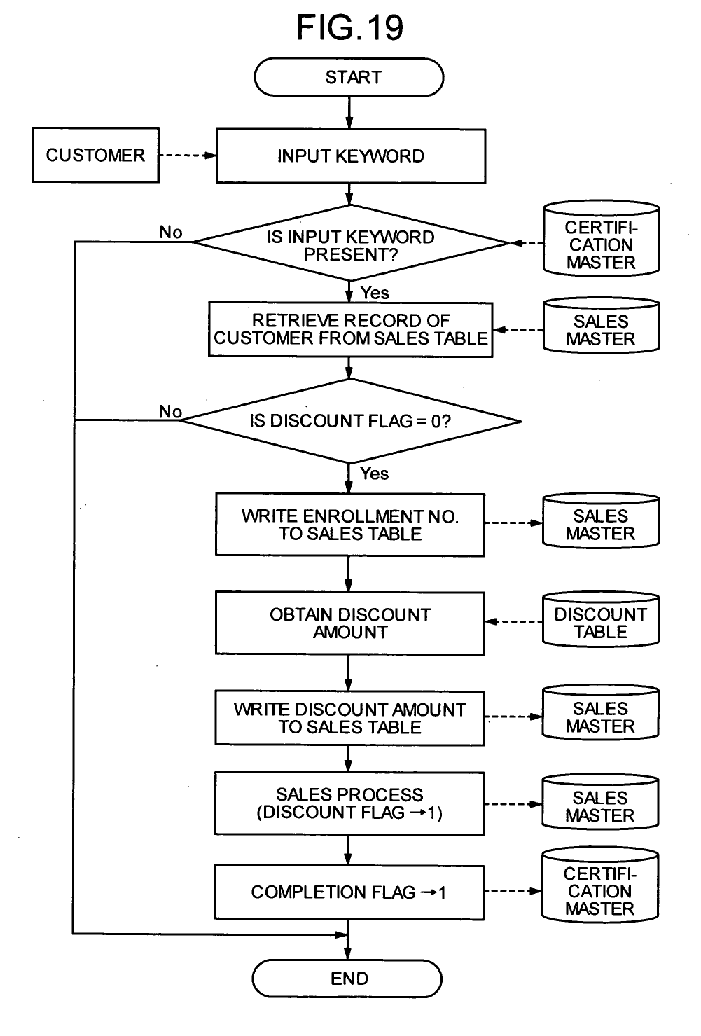

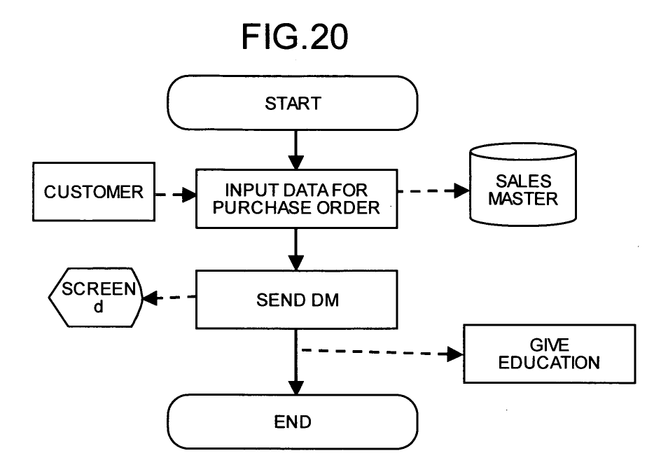

The coupon issuing unit 33b, as shown in FIG. 19, handles the process of issuing a discount coupon to customers who have taken the education course after purchasing a PC at a non-discounted price. In other words, the coupon issuing unit 33b first checks if the keyword supplied by the customer is present in the certification table (see FIG. 7) in the certification master 32e. If the keyword is present, the coupon issuing unit 33b refers to the sales table (see FIG. 16) in the sales master 32c to search for a sale record for the customer with the personal information of the customer and the product number of the PC as search keys.

If the search shows that the customer has purchased the PC and the discount flag in the sales table is “0”, the coupon issuing unit 33b writes the enrollment number of the corresponding record in the certification table in the certification,master 32e to the sales table in the sales master 32c. The coupon issuing unit 33b then refers to the discount table (see FIG. 17) in the discount table master 32d, the sales table in the sales master 32c, and the certification table in the certification master 32e to check if the PC that the customer desires to buy is available at a discount price and the customer has taken the education course. If all the conditions are satisfied, the coupon issuing unit 33b acquires the discount value from the discount table in the discount table master 32d and writes the discount value in the sales table in the sales master 32c as an amount that is to be paid back to the customer in the form of a coupon. The coupon issuing unit 33b then sets the discount flag in the sales table to.“1” to indicate that a coupon has been issued to the customer, and sets the completion flag to “1” in the certification table in the certification master 32e as a proof that the discount has been given to the customer in the form of the coupon.

The supplementary promotion unit 33c carries out an advertising process similar to the process by the education server 10 as a supplementary for the promotion by the education server 10. In other words, the supplementary promotion unit 33c sends a DM message that includes contents shown in FIG. 21 to the customer device 20 of the customer who tries to buy a PC without taking any education course. The DM message includes a message that certain PCs are available at a discount price if the customer takes a predetermined education course.

The present invention is not limited to the embodiment explained above, but can modified in various manners as explained below.

The education system is not limited to offering the education courses relating to the PCs. It may be modified to provide costumer support for software application and hardware of the PCs, home electronic appliances such as audio-visual equipments, travel packages offered by travel companies, and the like.

Moreover, instead of the customer selecting the education course, the education system may be modified to automatically select an education course that is relevant to the product the customer has purchased or the customer is going to purchase. This scheme is useful because in some cases it is difficult for the customer to decide which education course is relevant to the product.

Furthermore, the education system may be modified to select an education course that is common to a product group to which the product belongs, and then select an education course that is specific to the product. Assuming that many applications software are installed in a PC, an education course that is common to all the applications software may be first selected and, once the customer has taken that education course, education courses that are specific to each of the applications software may be selected. This scheme allows improvement of the knowledge of the customer from basic to advance step by step and facilitates easy and proper understanding of the product.

Moreover, the education system may be modified to select education courses based on the education courses previously taken by the customer. In other words, the education system may be modified not to select the education courses that are already taken by the customer or whose contents are similar to the education courses that are already taken by the customer. Assume that a customer has an old PC into which applications software A and B are pre-installed and he/she has taken education courses on both the applications software A and B when he/she purchased the old PC, and now the same customer is purchasing a new PC into which applications software A and C are pre-installed. In this particular case, the education system may only select the education course on the applications software C for the customer; because the customer has already taken the education course on the software application A. This scheme avoids same or similar education courses being taken repeatedly.

Furthermore, instead of giving a flat discount, the education system may be modified to change the amount of the discount based on the score of the customer in the test. For instance, 10% discount may be given to the customers who acquire 100% marks and 9% discount may be given to the customers who acquire 90% marks in the test. Because the customer gets more discounts if he/she acquires higher marks, this motivates the customer to study the product harder to acquire higher marks, and consequently makes the customer more knowledgeable.

Moreover, the benefits may be given in forms other than the discount or the coupon. For example, the benefits may be awarded in the form of points. The points may be written on or stored in a loyalty card, for example, so that a discount equivalent to the points accumulated can be obtained at some other time.

Moreover, the education server 10 and the vendor server 30 may be a single unit instead of having them separately. This allows cost reduction. However, it is preferable that the education server 10 and the vendor server 30 are separate units if the education server 10 covers products of two or more vendors or when the public utility or the neutrality of the education server 10 as an education system is of importance.

Furthermore, the structures and functions of the apparatuses, devices, and the units shown in the drawings are exemplary. In other words, a part of the structure of and the function performed by a unit may be allocated to other unit.

Furthermore, some or all of the automatic processes explained above may even be carried out manually, and vice versa. The sequence of processes, the sequence of controls, specific names, and data including various parameters may be changed as required unless and until the results are the same.

The processes or methods explained above can be realized by executing computer programs pre-installed in a computer system such as a PC or a workstation.

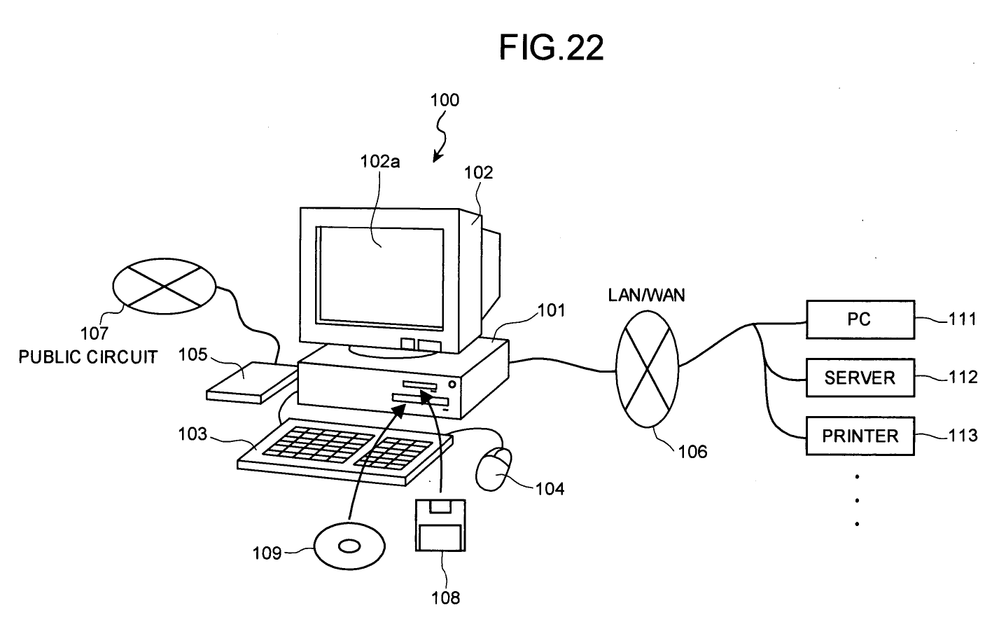

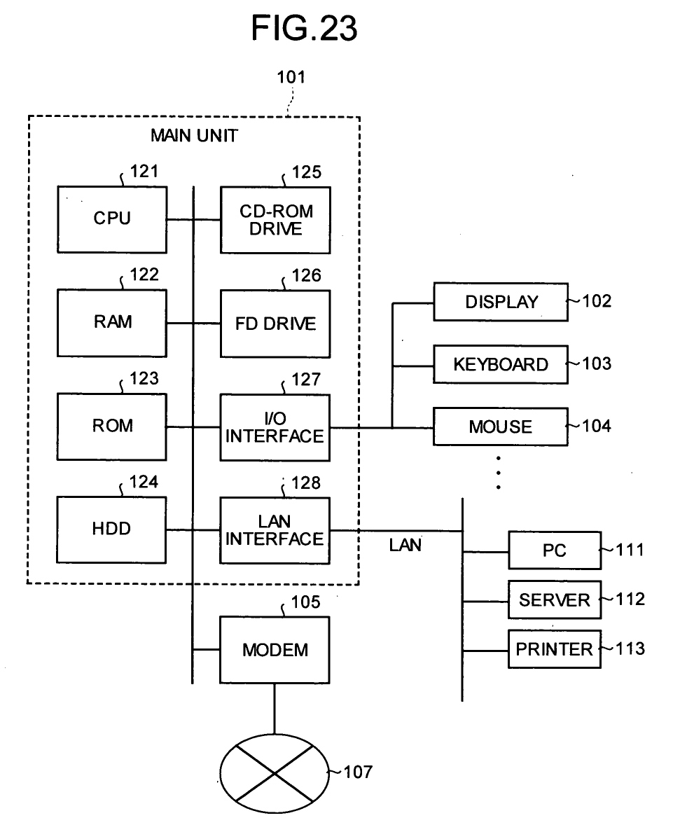

FIG. 22 is a schematic of a computer system that makes it possible to realize the apparatus and the steps in the method according to the present invention on a computer. FIG. 23 is a block diagram of a main unit of the computer system. A computer system 100 includes a main unit 101, a display 102 that includes a display screen 102a to display different tables mentioned above, a keyboard 103 for inputting data, and a mouse 104 for pointing an item on the display screen 102a.

The main unit 101 includes a central processing unit (CPU) 121, a random-access-memory (RAM) 122, a read-only-memory (ROM) 123, a hard disk drive (HDD) 124, a compact disk-read only memory (CD-ROM) drive 125 that can read data from or write data on a CD-ROM 109, a flexible disk (FD) drive 126 that can read data from or write data on an FD 108, an input/output (I/O) interface 127 to which the display 102, the keyboard 103, and the mouse 104 are connected, and a local area network (LAN) interface 128 that is connected to a local area network/wide area network (LAN/WAN) 106.

The computer system 100 is connected to a public circuit 107 such as the Internet via a modem 105. Another computer system (PC) 111, a server 112, and a printer 113 are connected to the computer system 100 via the LAN interface 128 and the LAN/WAN 106.

The computer system 100 realizes the functions of the education server 10 and the vendor server 30 by reading and executing the computer programs recorded in a recording medium. The recording medium may be a portable medium such as the FD 108, the CD-ROM 109, a magneto-optical (MO) disk, a digital versatile disk (DVD), and an IC card. The recording medium may be a fixed medium such as the HDD 124 that is one of internal and external drives, the RAM 122, and the ROM 123. On the other hand, the computer programs may be downloaded temporarily from other computers via the public circuit 107 or from the computer system 111 or the server 112 via the LAN/WAN 106.

Thus, the present invention provides a means and a method that allows the customer support to be provided with ease and at low cost. The prices-of the products can be kept low because there is no need to add an extra charge to the actual price for providing the customer support. The vendors do not have to invest on the call centers.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing, via a network, a customer device of a customer with information on a product that requires the customer to follow a predetermined operation procedure to operate a predetermined function, comprising:
an education giving unit that gives an education on the operation procedure of the product to the customer through the customer device; and
an education history storing unit that stores a progress of the education given to the customer as a history of the education given.

2. The apparatus according to claim 1, wherein the education giving unit gives the education according to a product category to which the product belongs.

3. The apparatus according to claim 2, wherein the education giving unit first gives an education that is common to all products in the product category, followed by an education that is specific to the product.

4. The apparatus according to claim 1, wherein the education giving unit gives the education according to the history stored.

5. The apparatus according to claim 1, wherein
the education giving unit conducts a test to check how much the customer has understood the operation of the product, and
the education history storing unit stores a result of the test as the history.

6. The apparatus according to claim 5, further comprising a benefit offering unit that offers the customer a benefit according to the result of the test.

7. The apparatus according to claim 6, wherein the benefit offering unit offers the benefit according to the history stored.

8. The apparatus according to claim 6, wherein the benefit offering unit offers the benefit in the form of at least one of a discount, a coupon, and points.

9. The apparatus according to claim 7, wherein the benefit offering unit offers the benefit in the form of at least one of a discount, a coupon, and points.

10. The apparatus according to claim 1, wherein the product is an application software and the product category is a computer.

11. A method of providing, via a network, a customer device of a customer with information on a product that requires the customer to follow a predetermined operation procedure to operate a predetermined function, comprising:
giving an education on the operation procedure of the product to the customer through the customer device; and
storing a progress of the education given to the customer as a history of the education given.

12. The method according to claim 11, wherein the giving includes giving the education according to a product category to which the product belongs.

13. The method according to claim 12, wherein the giving includes giving an education that is common to all products in the product category, followed by giving an education that is specific to the product.

14. The method according to claim 11, wherein the giving includes giving the education according to the history stored.

15. The method according to claim 11, further comprising conducting a test to check how much the customer has understood the operation of the product, wherein
the storing includes storing a result of the test as the history.

16. The method according to claim 15, further comprising offering the customer a benefit according to the result of the test.

17. The method according to claim 16, wherein offering includes offering the benefit according to the history stored.

18. The method according to claim 16, wherein the offering includes offering the benefit in the form of at least one of a discount, a coupon, and points.

19. The method according to claim 17, wherein the offering includes offering the benefit in the form of at least one of a discount, a coupon, and points.

20. A computer program for providing, via a network, a customer device of a customer with information on a product that requires the customer to follow a predetermined operation procedure to operate a predetermined function, making a computer execute:
giving an education on the operation procedure of the product to the customer through the customer device; and
storing a progress of the education taken by the customer as a history of the education given.
